(19) United States
(12) Patent Application Publication
(10) Pub. No.: US 2017/0043457 A1
(43) Pub. Date: Feb. 16, 2017

(54) ELECTRIC POWER TOOL

(71) Applicant: MAKITA CORPORATION, Anjo-shi (JP)

(72) Inventor: Kazunori TSUGE, Anjo-shi (JP)

(73) Assignee: MAKITA CORPORATION, Anjo-shi (JP)

(21) Appl. No.: 15/126,639

(22) PCT Filed: Mar. 31, 2015
(86) PCT No.: PCT/JP2015/060128

§ 371 Date: Sep. 16, 2016

(30) Foreign Application Priority Data
Apr. 9, 2014 (JP) 2014-080407

(51) Int. Cl. B25B 21/00; B25F 5/02

(52) U.S. Cl. CPC B25B 21/00; B25F 5/02

(57) ABSTRACT

In a tightening tool for tightening a nut to a shear bolt, e.g., a shear wrench by which a chip is cut and a predetermined torque for tightening the nut is obtained, the handling property of the tool can be improved while readily available and commonly used versatile 18V batteries are used as a power source to obtain a high output. Two 18V batteries are attached side-by-side on a battery attaching part as the power source. The two 18V batteries are electrically connected in series to output 36V power source. The battery attaching part is provided so as to straddle a lower portion of the motor unit and a lower portion of the handle unit, such that a center of gravity can be lowered, and stability of the handling property of the tool can be improved.

### TECHNICAL FIELD

The present invention relates to an electric power tool having a rechargeable battery pack as a power source.

### BACKGROUND ART

In recent years, in mainly hand-held electric power tools such as screwdrivers and cutting machines, rechargeable battery packs have been provided as power sources instead of commercially available 100V power sources that are supplied via a power cable. The rechargeable battery packs help the electric power tools to operate in a cordless manner. In the electric power tools with said battery packs as described above, the battery pack used as the power source has an output voltage that is compliant with the rated voltage of an electric motor housed in the tool main body as a drive source. Therefore, for example, if the rated voltage of the electric motor is 36V, then a battery pack having an output voltage of 36V is attached as a power source therefor. Battery packs with various rated voltages such as 18V, 14.4V, or 7.2V in addition to 36V can also be used.

These battery packs are, for example, lithium ion batteries, where each battery pack includes a plurality of battery cells housed in a case, and each battery pack is configured to be repeatedly used by being detached from the tool main body and charged with a separately provided charger. A related background art concerns a screw-tightening device referred to as a shear wrench, as disclosed in Patent Documents (Japanese Laid-Open Patent Publication No.H11-871 and Japanese Laid-Open Patent Publication No. 2012-35382).

### SUMMARY OF INVENTION

### Problems to be Solved by the Invention

However, in the screw tightening device as described in the known art above, the device construction and layout, including inter alia, the attaching orientation of the battery pack, needs a further improvement. It is an object of the present invention to improve mainly an attaching feature of a battery pack of an electric power tool such that a 36V electric power tool can be operated, for example, by attaching 18V batteries as a power source.

### Means for Solving the Problems

The above-described problem is solved by multiple aspects of the instant invention as described below. A first invention provides an electric power tool for rotating a socket sleeve to tighten a nut to a shear bolt by an electric motor as a drive source. In the first invention, the electric power tool includes a plurality of battery coupling sections and each battery coupling section is used for attaching a rechargeable slide-attaching type battery pack as a power source for the electric motor. According to the first invention, the plurality of battery packs attached to the battery coupling sections are electrically connected in series, so that the electric power tool may be used as a high-output electric power tool. For example, a 36V-specific electric power tool may be used by preparing two 18V batteries from a plurality of batteries that the user may source from backup batteries, etc., wherein attaching the two battery packs having a rated voltage of 18V allows the user to use the 36V-specific electric power tool. Accordingly, with effective usage of the backup batteries, the cost for the batteries may be reduced and handling property (versatility) of the 36V-specific electric power tool may be improved.

A second invention provides the electric power tool according to the first invention, including a tool main body extending in a forward and rearward direction, a motor unit protruding sideward from a side portion of the tool main body, and a handle unit extending from a rear portion of the tool main body along the motor unit. Furthermore, a battery attaching part is provided so as to straddle between a lower portion of the handle unit and a lower portion of the motor unit, and battery coupling sections are provided on a lower surface of the battery attaching part at two positions arranged side-by-side. According to the second invention, with the two relatively heavy battery packs attached to the lower portion, a center of gravity of the electric power tool may be set on the lower side, whereby the handling property of the electric power tool can be improved for a user who holds the handle unit.

A third invention is the electric power tool according to the second invention, in which the battery pack is configured to be attached and detached to the battery coupling section of the battery attaching part by being moved forward and rearward with respect to the battery coupling section. According to the third invention, the battery pack may be attached to the battery coupling section by being moved forward in a direction of an axis of the tool main body extending in the forward and rearward direction, while the battery pack may be detached from the battery coupling section by being moved rearward along said device axis. Accordingly, the user who holds the handle unit is allowed to easily attach and detach the battery pack, and the handling property of the electric power tool can further be improved.

A fourth invention is the electric power tool according to the second invention, in which the battery pack is configured to be attached and detached by being moved leftward and rightward with respect to the battery coupling section. According to the fourth invention, the user who holds the handle unit is capable of attaching and detaching the battery pack by moving the pack rightward and leftward with respect to the battery coupling section.

A fifth invention is the electric power tool according to the second invention, in which each of the battery coupling sections is provided on a left and right side of the motor unit, respectively, and the battery pack is attached and detached by being moved upward and downward with respect to the battery coupling section. According to the fifth invention, the user who holds the handle unit is capable of attaching and detaching the battery pack by moving the pack upward and downward with respect to the battery coupling section. Furthermore, according to the fifth invention, the battery coupling sections may be provided on both sides of the motor unit, so that the electric power tool is configured to be compact in height.

A sixth invention is the electric power tool according to the second invention, in which each of the battery coupling sections is provided on a left and right side of the motor unit, respectively, and the battery pack is attached and detached by being moved forward and rearward with respect to the battery coupling section. According to the sixth invention, a user who holds the handle unit is capable of attaching and detaching the battery pack by moving the pack forward and rearward with respect to the battery coupling section. According to the sixth invention, the battery coupling sections may be provided on both sides of the motor unit, so that the electric power tool is configured to be compact in height.

A seventh invention provides an electric power tool for rotating a socket sleeve to tighten a nut to a shear bolt by an electric motor as a drive source, including a battery coupling section used for attaching a rechargeable slide-attaching type battery pack as a power source for the electric motor. According to the seventh invention, the nut tightening operation with respect to the shear bolt can be performed by using a rechargeable battery pack (secondary battery) as a power source, whereby efficiency of the nut tightening operation may be improved compared to a case where an AC power source is used as the power source. In addition, the slide-attaching type battery pack may be effectively used with respect to electric power tools such as a shear wrench. Thus there is a wide scope in application, where slide-attaching type battery packs powering electric power tools can be used.

### BRIEF DESCRIPTION OF THE DRAWINGS

FIG. 1 is a general perspective view illustrating an example of an electric power tool of a first embodiment of the invention. In this embodiment, a shear wrench is exemplified as the electric power tool.

FIG. 2 is a vertical cross-sectional view illustrating an example of the electric power tool of the first embodiment.

FIG. 3 is a bottom view illustrating an example of the electric power tool of the first embodiment. This drawing shows a state in which two battery packs are detached from a battery attaching part and accordingly a battery coupling section can be seen.

FIG. 4 is a perspective view illustrating an example of a single battery.

FIG. 5 is a top view illustrating an example of the single battery viewed in a direction indicated by an arrow (V) in FIG. 4.

FIG. 6 is a rear view illustrating an example of the single battery viewed in a direction indicated by an arrow (VI) in FIG. 4.

FIG. 7 is a general perspective view illustrating an example of an electric power tool of a second embodiment.

FIG. 8 is a general side view illustrating an example of the electric power tool of the second embodiment.

FIG. 9 is a general perspective view illustrating an example of an electric power tool according to a third embodiment.

FIG. 10 is a general side view illustrating an example of the electric power tool according to the third embodiment.

FIG. 11 is a general perspective view illustrating an example of an electric power tool of a fourth embodiment.

FIG. 12 is a general side view illustrating an example of the electric power tool according to the fourth embodiment.

FIG. 13 is a general perspective view illustrating an example of an electric power tool according to a fifth embodiment.

FIG. 14 is a rear view illustrating an example of the electric power tool according to the fifth embodiment viewed in a direction indicated by an arrow (XIV) in FIG. 13.

FIG. 15 is a general perspective view illustrating an example of an electric power tool according to a sixth embodiment.

FIG. 16 is a general side view illustrating an example of the electric power tool according to the sixth embodiment.

FIG. 17 is a general perspective view illustrating an example of an electric power tool according to a seventh embodiment.

FIG. 18 is a general side view illustrating an example of the electric power tool according to the seventh embodiment.

### EMBODIMENTS FOR CARRYING OUT THE INVENTION

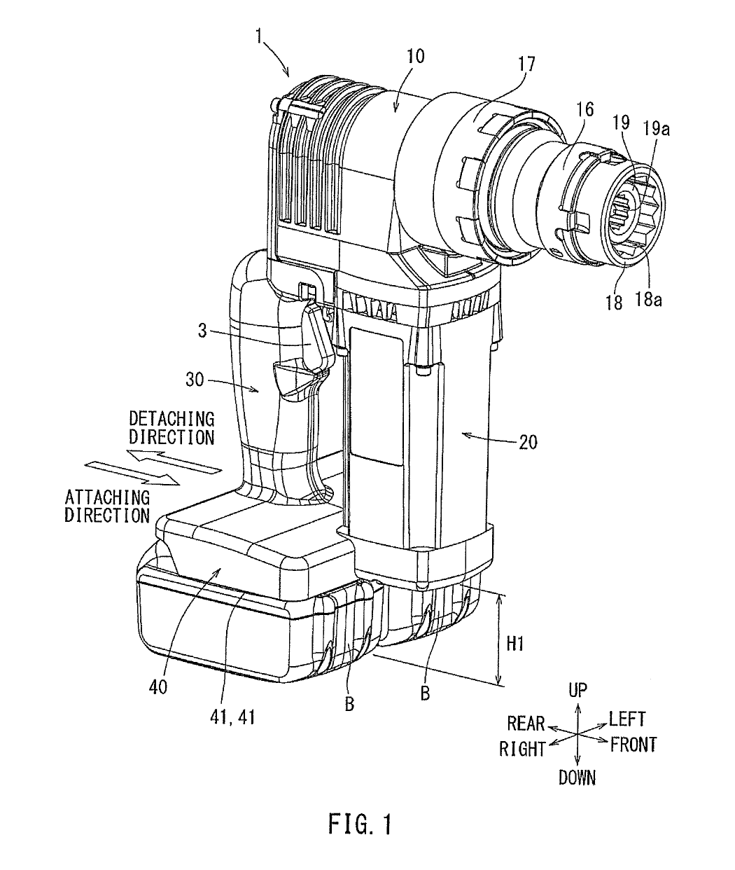

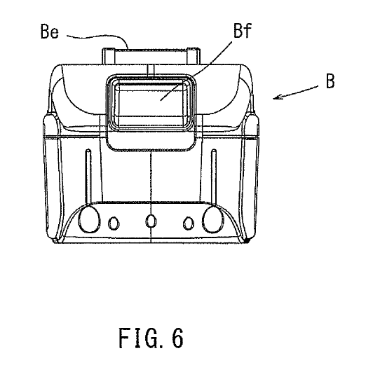

Referring now to FIG. 1 to FIG. 18, embodiments of the present invention will be described. FIG. 1 illustrates an electric power tool 1 according to this embodiment. In this embodiment, a so-called shear bolt tightening tool (shear wrench) is described as an example of an electric power tool. The electric power tool 1 may include a tool main body 10, a motor unit 20, a D-shaped handle unit 30 that a user holds, and a battery attaching part 40 for attaching a battery pack B as a power source. The motor unit 20 may be provided to protrude downward from a side portion of the tool main body 10. The handle unit 30 may be provided rearward of the motor unit 20. The battery attaching part 40 may be provided below the handle unit 30. Two battery packs B with a rated voltage of 18V may be attached to the battery attaching part 40.

An electric motor 2 with a rated voltage of 36V may be attached inside the motor unit 20. The electric motor 2 may be activated when a main switch 4 is turned on by manipulating switch lever 3 which has a trigger-type configuration provided on an upper front surface of the handle unit 30. A DC brushless motor may be used as the electric motor 2. The electric motor 2 may include a rotor 2c fixed to an output shaft 2b and a stator 2d disposed around the rotor 2c. The stator 2d may include a coil wound therearound. The stator 2d may be fixed to a motor case 2e via an electric insulating member (insulator) 2f. The electric insulating member 2f may be provided with a sensor board 2g having a magnetic sensor for sensing a rotation of the rotor 2c at an upper portion thereof. The output shaft 2b may be provided with a fan 2h for cooling the motor attached to an upper portion thereof. The motor case 2e may include a controller 2i for controlling the rotation of the electric motor 2 housed in a lower portion thereof. The controller 2i may be provided with various electronic members such as cooling fins 2j and FET 2k attached thereon.

The rotation of the electric motor 2 may be transmitted to an intermediate shaft 7 via a pinion gear 2a, an intermediate gear 5, and an intermediate gear 6 formed at a distal end of the output shaft 2b. The intermediate shaft 7 may be provided with a bevel gear 7a formed at a distal end thereof, which is engaged with a bevel gear 8. The bevel gear 8 may be rotatably supported via the bearings 8a, 8b about a device axis J of the tool main body 10.

A rotating output of the bevel gear 8 may be transmitted to an output sleeve 14 and a front sleeve 16 via first to third planet gear trains 11 to 13. The output sleeve 14 may be coupled to a carrier of the third planet gear train 13, and the front sleeve 16 may be coupled to an internal gear of the third planet gear train 13. Therefore, the output sleeve 14 and the front sleeve 16 may rotate in opposite directions from each other. The output sleeve 14 may be rotatably supported via an inner wheel side of a bearing 15, and the front sleeve 16 may be rotatably supported by a body housing 17 via an outer wheel side of the bearing 15. The front sleeve 16 may include a socket sleeve 18 fixed to a front end thereof. The socket sleeve 18 may be disposed coaxially with the output sleeve 14.

An inner sleeve 19 may be supported on an inner peripheral side of the output sleeve 14 and the socket sleeve 18. The inner sleeve 19 may be biased by a compression spring 34 toward the front direction with respect to the output sleeve 14. An outer peripheral side of the inner sleeve 19 may be spline-fitted into an inner peripheral surface of the output sleeve 14. Accordingly, the output sleeve 14 and the inner sleeve 19 may rotate integrally with each other about the device axis J.

An inner peripheral surface of the inner sleeve 19 may be provided with a tip fitting portion 19a. An anti-slipping pin 37 may protrude within the tip fitting portion 19a. The anti-slipping pin 37 may be forwardly biased by the compression spring 32 toward the protruding side with respect to the inner sleeve 19. When the tip is completely fitted into the tip fitting portion 19a of the inner sleeve 19 and the above-described anti-slipping pin 37 is retracted from the interior of the tip fitting portion 19a, a stopper 33 provided on a peripheral surface of the inner sleeve 19 may be retracted to an inner peripheral side of the inner sleeve 19 to allow the inner sleeve 19 to move inward of the output sleeve 14. Because of this configuration, the nut may not be allowed to be fitted on the nut fitting portion 18a of the socket sleeve 18 unless the tip is first completely fitted into the tip fitting portion 19a of the inner sleeve 19, whereby slippage of the tip can be prevented.

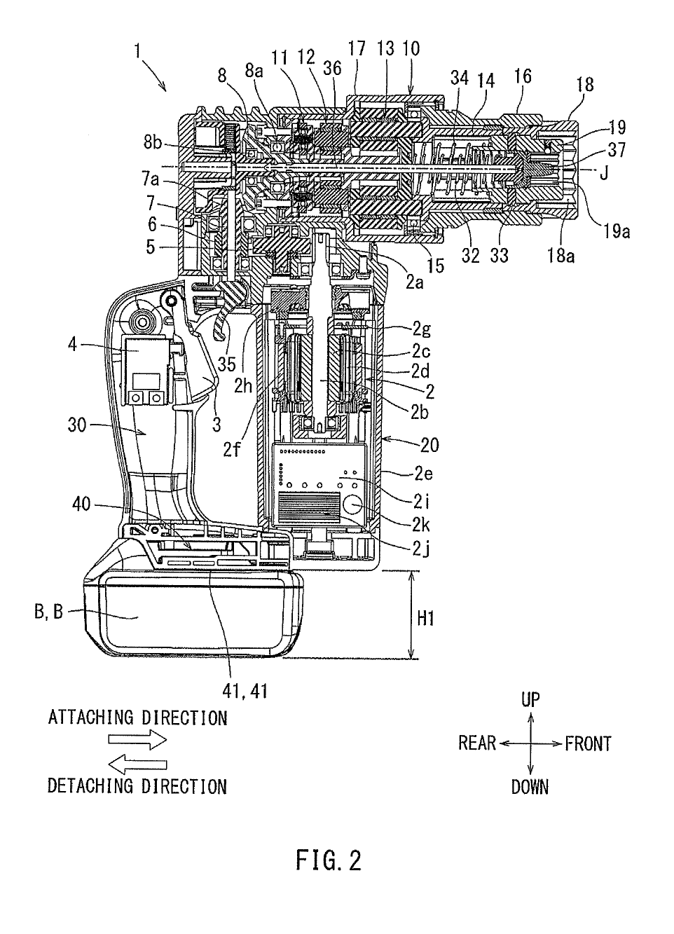

According to a drive force transmitting route and a tightening mechanism configured as described above, a nut (not illustrated) of a shear bolt may be fitted into the nut fitting portion 18a of the socket sleeve 18 while retracting the inner sleeve 19 against the compression spring 34 in a state in which the tip of the shear bolt (not illustrated) may be completely fitted into the tip fitting portion 19a of the inner sleeve 19. In this stage, the inner sleeve 19 is spline fitted into the output sleeve 14. In this state, when the switch lever 3 is turned on to activate the electric motor 2, the socket sleeve 18 may rotate and the nut may be tightened onto the shear bolt. The cut tip may be discharged from the tip fitting portion 19a by the anti-slipping pin 37 being projected forward by the compression spring 32. An exhaust lever 35 may be provided above the switch lever 3. By the exhaust lever 35 being pulled, a push-out pin 36 may be forced to move forward (rightward in FIG. 2), whereby the cut tip may be forcedly discharged from the tip fitting portion 19a.

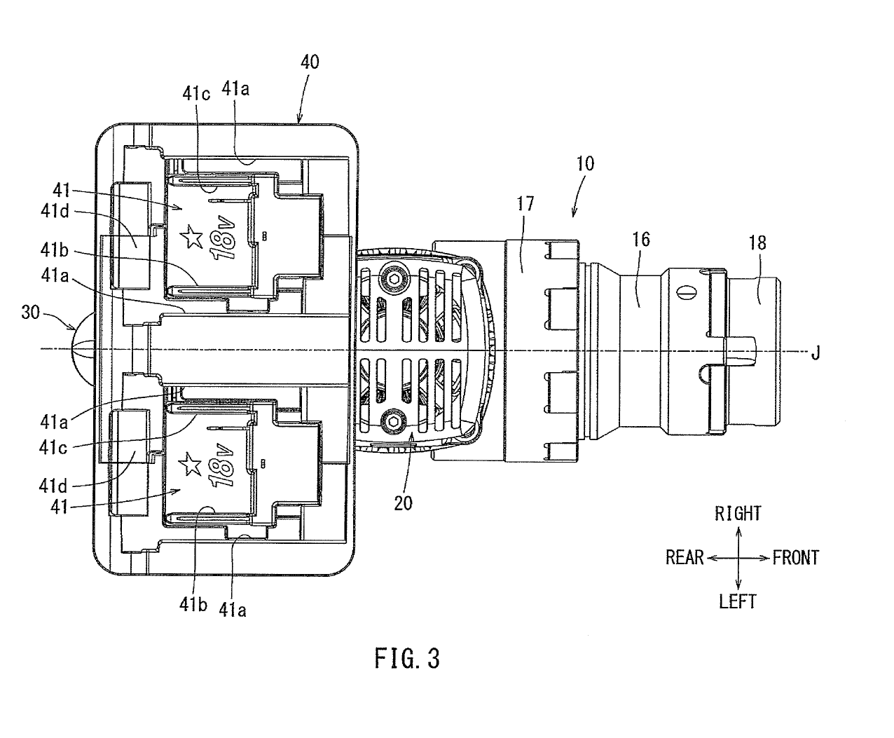

Next, the battery attaching part 40 may be provided below the D-shaped handle unit 30. The battery attaching part 40 may be provided such that it straddles a lower portion of the handle unit 30 and a lower portion of the motor unit 20. Two battery packs (also referred to as 18V batteries) B, where each pack B has a rated voltage of 18V, may be attached to the battery attaching part 40. The battery attaching part 40 is illustrated in detail in FIG. 3. Two battery coupling sections 41, 41 parallel to each other may be provided on a lower surface of the battery attaching part 40 in a side-by-side configuration in the left-to-right axis. Each one of the individual 18V batteries B may be attached to both of the battery coupling sections 41.

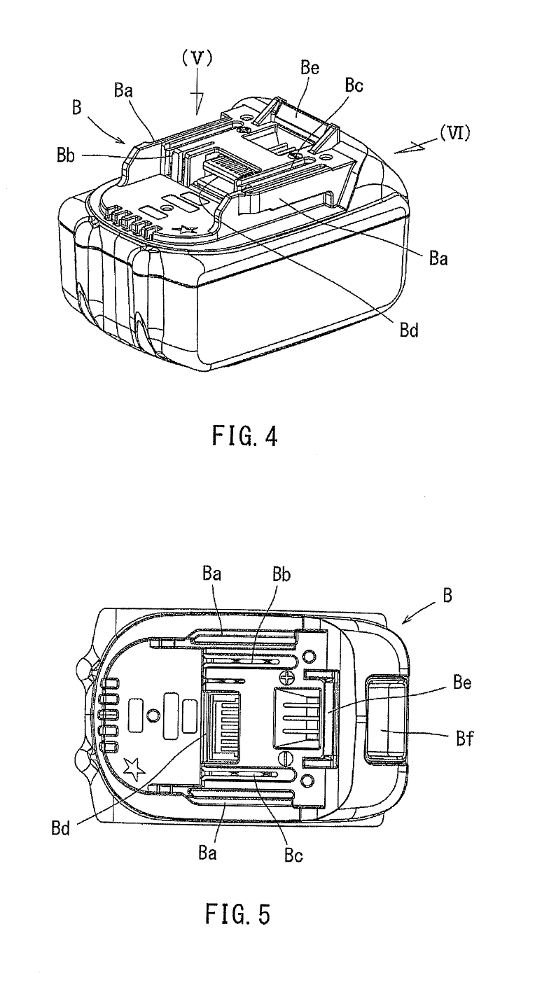

In this embodiment, a lithium ion battery including a plurality of cells housed in a battery case may be attached as the 18V battery. The 18V batteries B, B may be slide-attaching type batteries, which though they may be used as a power source for other electric power tools such as an electric cutting machine, may also be used for the electric power tool 1. The battery packs B, B may also continue to be used as the power sources repeatedly by being detached from the battery coupling sections 41, 41 and being recharged with a separately provided charger. The battery B having a parallelepiped shape as illustrated in FIG. 4 to FIG. 6 may be provided with a pair of left and right rail receiving portions Ba, Ba on an upper surface thereof. Positive and negative terminal receiving portions Bb, Bc may be disposed between both rail receiving portions Ba, Ba. A connector portion Bd configured to transmit and receive a control signal with respect to a charger when charging with the charger may be provided between the positive and negative terminal receiving portions Bb, Bc. A locking claw Be may be provided on a rear portion of an upper surface of the battery pack B. The locking claw Be may be biased upward by a spring in a protruding direction. The locking claw Be may be moved downward to an unlock position against a spring biasing force by pushing an unlock button Bf provided on a rear surface of the battery downward with a fingertip.

The two battery coupling sections 41, 41 may have the same configuration as illustrated in FIG. 3. Both of the battery coupling sections 41, 41 may be electrically connected in series to each other. One of the battery coupling sections 41 will be described, and elements in common with the other battery coupling section 41 will be omitted by allocating the same reference numerals. The battery coupling section 41 may be provided with a pair of left and right rails 41a, 41a. Positive and negative connecting terminals 41b and 41c, respectively, may be disposed between both of the rail portions 41a, 41a. An engaging depression 41d into which the locking claw Be (see FIG. 4) of the battery pack B is fitted may be provided on a rear portion of the battery coupling section 41.

As illustrated in FIG. 3, the battery pack B may be mechanically coupled to the battery coupling section 41 by engaging the rail receiving portions Ba, Ba with the rail portions 41a, 41a while sliding (translating) the battery pack B forward (rightward in the drawing) with respect to the battery coupling section 41. When the battery pack B is mechanically coupled to the battery coupling section 41, the positive and negative connecting terminals 41b, 41c on the battery coupling section 41 side may enter the terminal receiving portions Bb, Bc and may be electrically connected to the terminal receiving portions Bb, Bc on the battery pack B side. When the battery pack B is mechanically coupled to the battery coupling section 41, the locking claw Be may be locked into a attached state in which the locking claw Be may be elastically fitted into the engaging depression 41d and the battery pack B may be fixed so as not to be capable of moving in the sliding direction. As used throughout this specification, the battery packs B, B of a slide-attaching type may mean that the batteries are configured to be attached by being translated in a state in which the rail portions 41a, 41a on the battery coupling section 41 side engage with the pair of rail receiving portions Ba, Ba provided on one surface (upper surface).

When detaching the attached battery pack B from the battery coupling section 41, the battery pack B may be pulled out rearward with the unlock button Bf pressed downward. Accordingly, the rail receiving portions Ba, Ba may be disconnected from the rail portions 41a, 41a, and the connecting terminals 41b, 41c may be separated from the positive and negative terminal receiving portions Bb, Bc, so that the battery pack B may be detached from the battery coupling section 41. In this manner, by setting the attaching and detaching direction of the battery packs B, B to be the forward and rearward direction, a user may be allowed to easily perform attaching and detaching operation of the batteries B, B with respect to the battery coupling sections 41, 41 of the batteries B, B. Since this configuration allows the batteries B, B to be detached by being slid rearward (toward the user), the battery packs B, B may be prevented from falling where the battery packs may have been improperly attached inadvertently.

When the two 18V battery packs B, B are attached to the battery coupling sections 41, 41 provided as described above, both of the battery packs B, B may be electrically connected in series and may serve as a power source that can output a rated voltage of 36V, which is a summed voltage. The electric motor 2 may be activated by the power source with the rated voltage of 36V output from both of the battery packs B, B, and as a result the nut can be tightened.

According to the electric power tool 1 of the first embodiment described thus far, the two battery packs B, B attached to the battery coupling sections 41, 41 may be electrically connected in series, so that the electric power tool 1 may be used as a 36V-specific electric power tool. In this manner, by preparing two 18V batteries B, B from a plurality of already existing batteries B, B that the user has as backup battery packs B, the 36V-specific electric power tool 1 may be used. Accordingly, with effective usage of the backup 18V batteries B, the cost for the battery may be reduced and handling property (versatility) of the 36V-specific electric power tool 1 may be improved.

In addition, the two battery packs B, B may be configured to be attached to a lower portion of the handle unit 30 on the rear side in the device axis direction. Thereby, a large dimension protruding forward from the motor unit 20 of the tool main body 10, that is a so-called arm dimension, can be obtained. The large arm dimension may improve the handling property and workability of the electric power tool 1 such that any tightening operation can be performed by the power tool in a narrow region. In addition, since the configuration is not such that the battery packs B, B are provided on the upper surface of the tool main body 10, the dimension from the device axis J to the upper surface of the tool main body 10 (center height) may be reduced, and accordingly the handling and workability of the electric power tool 1 can be improved.

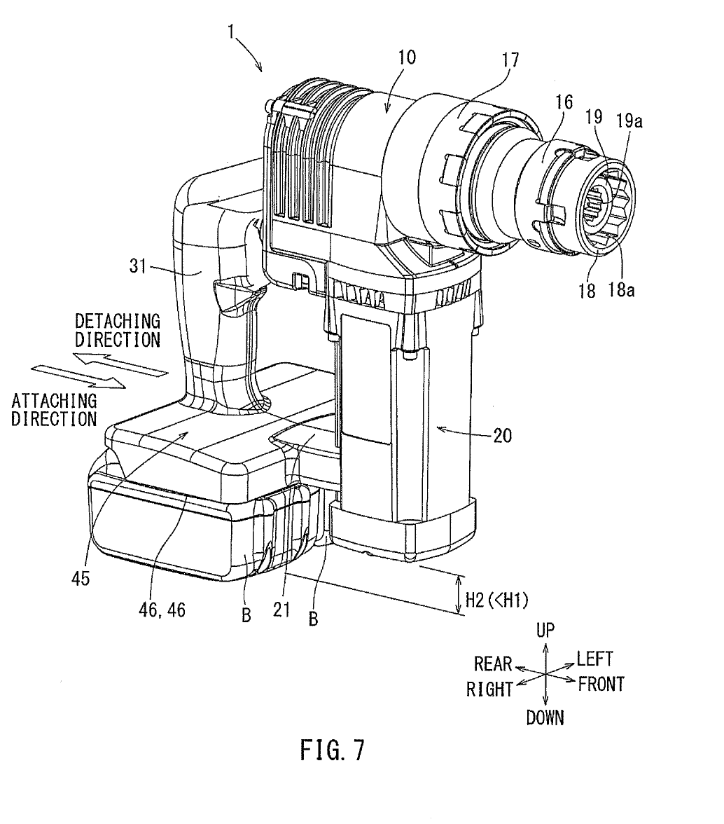

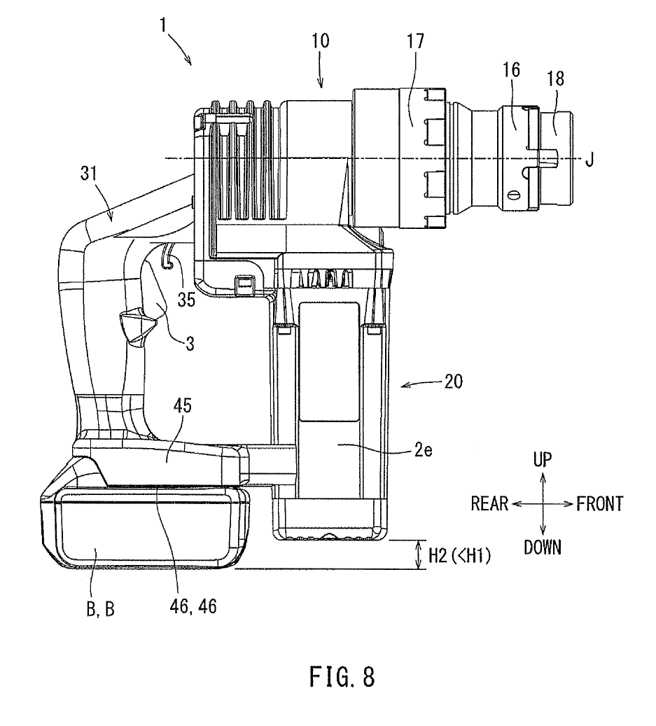

FIG. 7 and FIG. 8 illustrate an electric power tool 1 according to a second embodiment. The electric power tool 1 of the second embodiment may be different from that of the first embodiment in attaching height of the two battery packs B, B. Descriptions of members and configurations in common with the first embodiment may be omitted by using the same reference numerals. In the second embodiment, the attaching and detaching direction of the battery packs B, B may be in the forward and rearward direction as with the first embodiment. In other words, the battery pack B may be detached from a battery coupling section 46 by sliding the battery pack B rearward with respect to a battery attaching part 45. In contrast, by sliding the battery pack B from the rear toward the front of the battery attaching part 45, the battery pack B may be attached to the battery coupling section 46. In the same manner as in the first embodiment, the two battery coupling sections 46, 46 may be provided on a lower surface of the battery attaching part 45 side by side in the lateral direction. Each battery coupling section 46 may be configured in the same manner as that of the battery coupling section 41 according to the first embodiment.

Unlike the first embodiment, in the case of the second embodiment, a handle unit 31 may extend downward from a rear surface of the tool main body 10, and may be provided at a position that is shifted upward from the position in the first embodiment. An extension 21 may be provided on a rear surface of the motor unit 20. The extension 21 may be provided protruding rearward from the motor unit 20 at a position above a lower end thereof by a predetermined length. In the second embodiment, the battery attaching part 45 may be provided so as to straddle between the extension 21 and the lower portion of the handle unit 31. Therefore, the relative position of the battery attaching part 45 with respect to the motor unit 20 in a heightwise direction may be set to a position shifted upward from the position in the first embodiment.

According to the electric power tool 1 of the second embodiment, the position of the battery attaching part 45 with respect to the motor unit 20 may be set to a position shifted upward from that in the first embodiment, so that the two battery packs B, B may be attached at relatively higher positions. As illustrated, the height H2 from an installation plane (lower surface) of the battery packs B, B to the lower surface of the motor unit 20 may be smaller than the height H1 from an installation plane of the battery packs B, B to a lower surface of the motor unit 20 in the first embodiment illustrated in FIG. 2. Therefore, according to the electric power tool 1 of the second embodiment, height of the electric power tool 1 can be reduced.

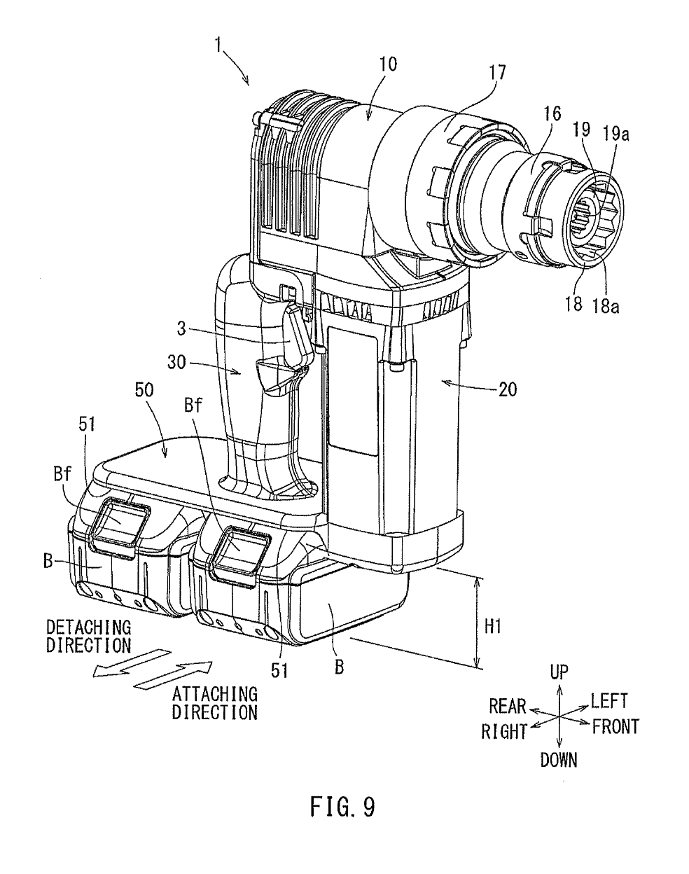

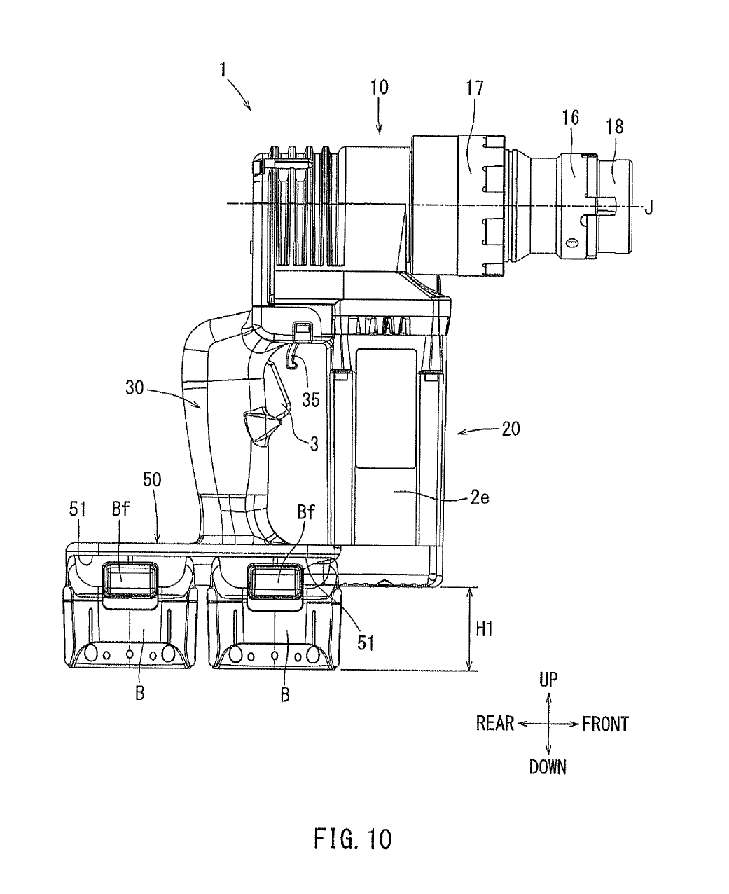

FIG. 9 and FIG. 10 illustrate an electric power tool 1 according to a third embodiment. The electric power tool 1 of the third embodiment may be different from that of the first and the second embodiments in the attaching and detaching direction of the two battery packs B, B. Descriptions of configurations and members in common with the first and second embodiments may be omitted by using the same reference numerals. The battery coupling section 50 of the third embodiment may be different from that of the first and the second embodiments in that the attaching and detaching direction of the two battery packs B, B relative to the section are set to be in the left and right direction, respectively. Two battery coupling sections 51, 51 may be provided on a lower surface of the battery attaching part 50 in a side-by-side along the rear-to-front axis. Both of the battery coupling sections 51, 51 may be provided with the pair of left and right rail portions 41a, 41a and the positive and negative connecting terminals 41b, 41c in the same manner as in the first and the second embodiments. In the third embodiment, these may be disposed extending in the left-to-right axis.

In the third embodiment, the battery pack B may be attached to the battery coupling section 51 by being slid in the leftward direction toward the right-facing side of the battery coupling section 50. In contrast, the battery pack B may be detached from the battery coupling section 51 by being slid in the rightward direction. According to the third embodiment, since the two battery packs B, B are attached side-by-side along the rear-to-front axis, the length of the electric power tool 1 in both the left and right directions may be reduced, accounting for a reduced width compared with the first and second embodiments in which the battery packs are attached side by side in the left and right direction.

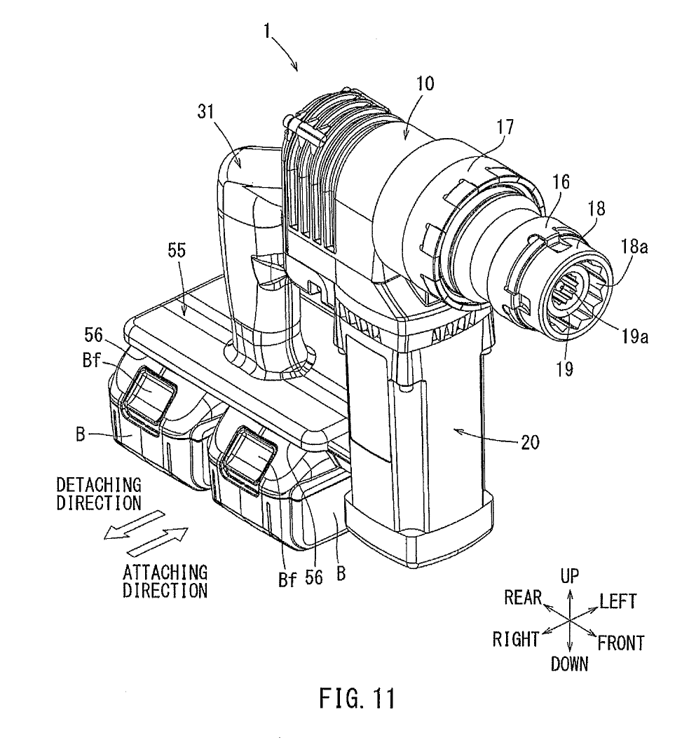

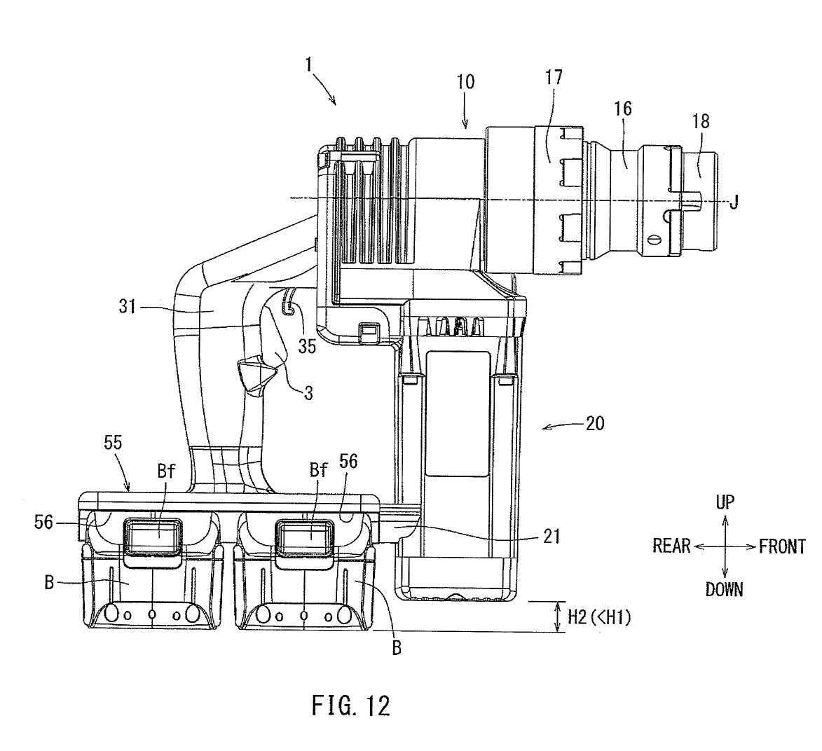

FIG. 11 and FIG. 12 illustrate an electric power tool 1 according to a fourth embodiment. The electric power tool 1 of the fourth embodiment may be different from that of the third embodiment with respect to the attaching height of the two battery packs B, B. Descriptions of members and configurations in common with the first to the third embodiments may be omitted by using the same reference numerals. In the fourth embodiment, the attaching and detaching direction of the battery packs B, B may be the left and right direction, respectively, as in the third embodiment. In other words, by sliding the battery pack B rightward (near side in FIG. 12) with respect to and away from the right-facing portion of battery attaching part 55, the battery pack B may be detached from a battery coupling section 56. In contrast, by sliding the battery pack B leftward towards the right-facing portion of the battery attaching part 55, the battery pack B may be attached to the battery coupling section 56.

In the case of the fourth embodiment, the handle unit 31 may extend downward from a rear surface of the tool main body 10, and may be provided at a position shifted upward from the position in the third embodiment. The extension 21 may be provided on a rear surface of the motor unit 20. The extension 21 may be provided protruding rearward from the motor unit 20 at a position above a lower end thereof by a predetermined length. In the fourth embodiment, the battery attaching part 55 may be provided so as to straddle between the extension 21 and the lower portion of the handle unit 31. This point may be the same as the second embodiment. Two battery coupling sections 56, 56 may be provided on a lower surface of the battery attaching part 55 in a side-by-side configuration along the rear-to-front axis. Therefore, the relative position of the battery attaching part 55 in the heightwise direction with respect to the motor unit 20 may be set to a position shifted upward from the position in the third embodiment.

According to the electric power tool 1 of the fourth embodiment, the position of the battery attaching part 55 with respect to the motor unit 20 may be set to a position shifted upward from that in the third embodiment, so that the two battery packs B, B may be attached at a relatively higher position. As illustrated in FIG. 12, a height H2 from the installation plane (lower surface) of the battery packs B, B to the lower surface of the motor unit 20 may be smaller than the height H1 from the plane of installation of the battery packs B, B to the lower surface of the motor unit 20 in the third embodiment illustrated in FIG. 9 and FIG. 10 (H2<H1). Therefore, according to the electric power tool 1 of the fourth embodiment, the height of the electric power tool 1 may be reduced compared with the third embodiment. According to the electric power tool 1 of the fourth embodiment, the height and lateral width of the tool may both be reduced in comparison with that of the electric power tool 1 of the first embodiment.

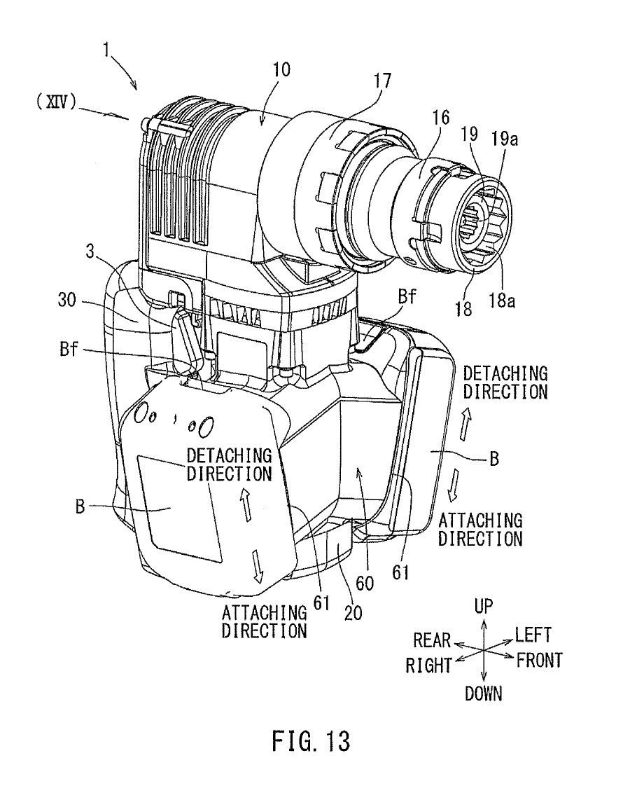

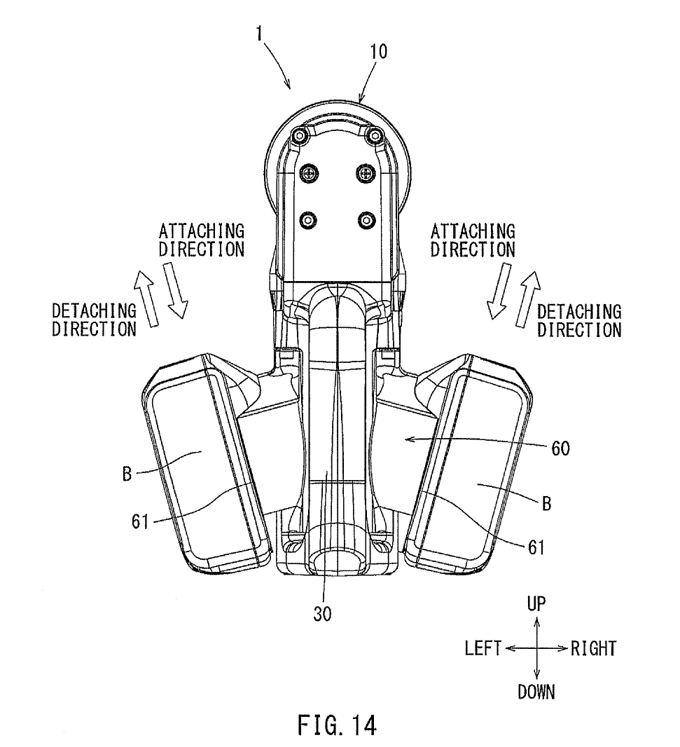

FIG. 13 and FIG. 14 illustrate an electric power tool 1 according to a fifth embodiment. The fifth embodiment may be further different from the first to the fourth embodiments with respect to the attaching state of the two battery packs B, B. Descriptions of configurations and members in common with the previous embodiments may be omitted by using the same reference numerals. In the fifth embodiment, each of the two battery coupling sections 61, 61 may be provided on the left and right side portions of the motor unit 20, respectively, which correspond to their respective battery attaching parts 60. The battery packs B may be attached to the left and right battery coupling sections 61, 61 by being slid downward. Conversely, the battery packs B may be detached from the left and right battery coupling sections 61, 61 by being slid upward.

The left and right battery coupling sections 61, 61 may be provided along inclined directions away from the handle unit 20 as they go upward as illustrated in FIGS. 13 and 14. Therefore, the two battery packs B, B may be attached to the battery coupling sections 61, 61 by being slid obliquely downward along these respective inclined directions toward each other. In contrast, the two battery packs B, B may be detached from the battery coupling sections 61, 61 by being slid obliquely upward along the inclined direction away from each other. According to the electric power tool 1 of the fifth embodiment, the height of the tool may further be reduced, and additionally the lateral width may also be reduced. Since the attaching and detaching direction of the battery packs B, B are in the vertical direction, the user who holds the handle unit 30 may attach and detach the battery packs B, B in an easier manner than in the case where the attaching and detaching direction is in the forward and rearward directions (the first and the second embodiments) or the left and right directions (the third and the fourth embodiments). Since the attaching and detaching directions of the battery packs B, B are inclined in the left and right direction, the battery packs B, B may be attached and detached quickly without considering interference with the tool main body 10 or the like, and from this point of view, the handling property (operability relating to attaching and detaching operation) of the battery pack B may be even further improved.

Instead of the laterally and obliquely attaching structure of the fifth embodiment, a configuration in which the left and right battery packs B, B are attached in parallel by positioning the left and right battery coupling sections 61, 61 in a parallel manner relative to each other may also be applied. In this configuration as well, the length of the tool in the forward and rearward directions and in the left and right directions in terms of space needed for attaching the battery packs B, B may be reduced.

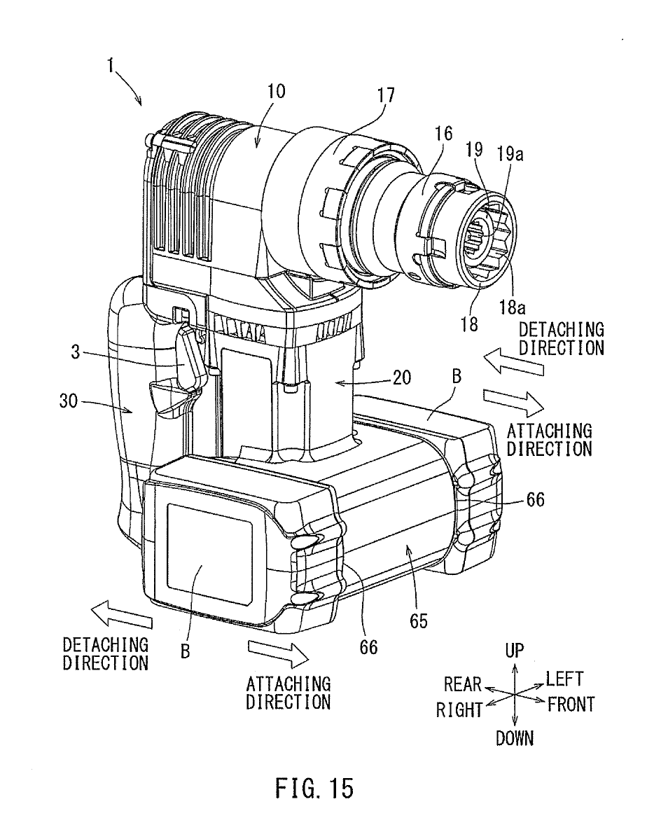

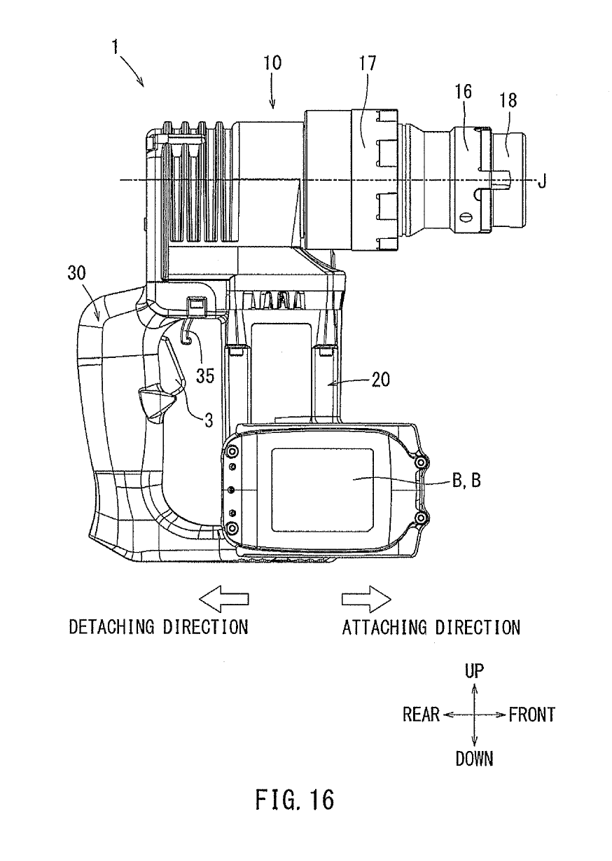

FIG. 15 and FIG. 16 illustrate an electric power tool 1 according to a sixth embodiment. Although the sixth embodiment is the same as the fifth embodiment in that the battery coupling sections 66, 66 are provided on the left and right side portions of the motor unit 20, it may be different from the fifth embodiment in that the battery packs B may be attached and detached in the forward and rearward direction. In the case of the sixth embodiment, a battery attaching part 65 may be provided below the motor unit 20. Battery coupling sections 66 may be provided respectively on right and left side portions of the battery attaching part 65. The left and right battery coupling sections 66, 66 may be provided such that they are parallel to each other.

In the sixth embodiment, the battery pack B may be attached by being slid toward the front, with respect to the battery coupling section 66. In contrast, the battery pack B may be detached by being slid rearward with respect to the battery coupling section 66. In the sixth embodiment, the lower portion of the handle unit 30 may extend forward and is coupled to the lower portion of the motor unit 20 and the battery attaching part 65 as illustrated in FIG. 16.

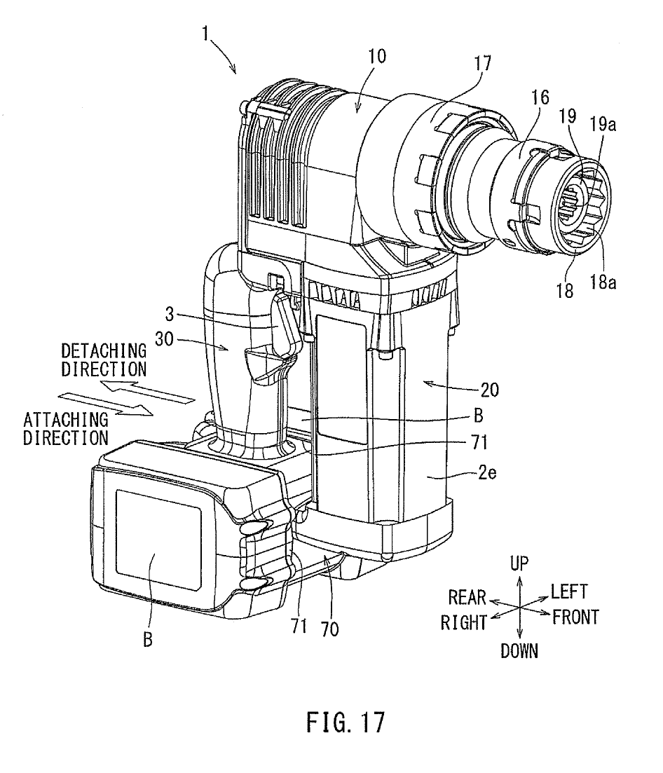

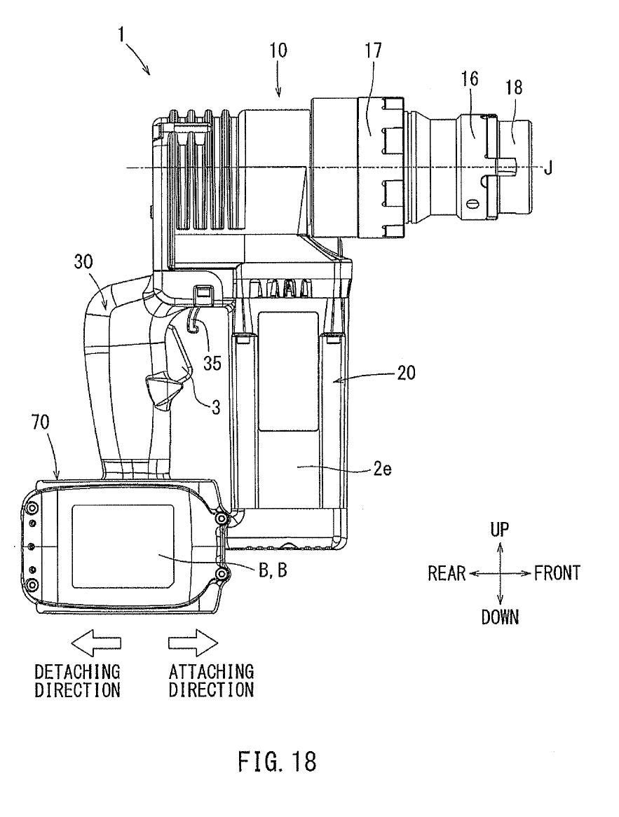

FIG. 17 and FIG. 18 illustrate an electric power tool 1 according to a seventh embodiment. The seventh embodiment may be different from the sixth embodiment in the position of a battery attaching part 70. In the seventh embodiment, the battery attaching part 70 may be provided at a position that is shifted toward below the handle unit 30 and hence that is shifted rearward relative to the battery attaching part in the sixth embodiment. Battery coupling sections 71 may be provided respectively on both right and left side surfaces of the battery attaching part 70. The left and right battery coupling sections 71, 71 may be provided such that they are parallel to each other. By sliding the battery pack B forward with respect to the battery coupling section 71, the battery pack B may be attached to the battery coupling section 71. In contrast, the battery pack B may be detached from the battery coupling section 71 by being slid rearward. A front portion of the battery attaching part 70 may be coupled to the lower portion of the motor unit 20.

According to the sixth and the seventh embodiments illustrated in FIG. 15 to FIG. 18, since the battery packs B are configured to be attached along the left and right side surfaces of battery attaching parts 65, 70, the lateral widths of the attaching spaces of the battery packs B, B may be reduced, and hence the overall lateral width length of the electric power tool 1 may also be reduced. As illustrated in FIG. 16, in the sixth embodiment, since the battery packs B, B are attached not being protruded from the motor unit 20, the dimension of the electric power tool 1 in the height direction may be configured to be reduced.

In the first to the seventh embodiments described above, further modifications may be made. For example, although the configuration in which the two battery packs B, B are attached is exemplified, specified effects and advantages may be obtained by applying the attaching position or the attaching direction as exemplified to the configuration in which three or more battery packs B to B are attached. Also, although the configuration in which the 36V power is supplied by attaching the two 18V batteries B, B is exemplified, configurations in which two or more 14.4V batteries or 7.2V batteries are attached in series to supply said 36V power may also be applicable.

Although the DC brushless motor is exemplified as the electric motor 2, a case where the brush motor is used as the drive source may be also applicable. Furthermore, although the shear wrench (the tightening tool for the shear bolt) is exemplified as the electric power tool, the exemplified configurations may be applied to layouts of the batteries for other electric power tools such as a boring drill or cutting machine.

1. An electric power tool for rotating a socket sleeve to tighten a nut to a shear bolt by an electric motor as a drive source, comprising:
a plurality of battery coupling sections, each battery coupling section used for attaching a rechargeable slide-attaching type battery pack as a power source for the electric motor.

2. The electric power tool according to claim 1, comprising:
a tool main body extending in a forward and rearward direction;
a motor unit protruding sideward from a side portion of the tool main body; and
a handle unit extending from a rear portion of the tool main body along the motor unit, wherein,
a battery attaching part is provided so as to straddle a lower portion of the handle unit as well as a lower portion of the motor unit; and
two battery coupling sections provided on a lower surface of the battery attaching part at two positions arranged side-by-side.

3. The electric power tool according to claim 2, wherein,
the battery packs are configured to be attached and detached by being moved forward and rearward, respectively, with respect to the battery coupling sections.

4. The electric power tool according to claim 2, wherein,
the battery packs are configured to be attached and detached by being moved leftward and rightward, respectively, with respect to the battery coupling sections.

5. The electric power tool according to claim 2, wherein,
each of the two battery coupling sections is provided on a left and right side of the motor unit, respectively; and
each battery pack is attached and detached by being moved upward and downward, respectively, with respect to the battery coupling section.

6. The electric power tool according to claim 2, wherein,
each of the two battery coupling sections is provided on a left and right side of the motor unit, respectively; and
each battery pack is attached and detached by being moved forward and rearward, respectively, with respect to the battery coupling section.

7. An electric power tool for rotating a socket sleeve to tighten a nut to a shear bolt by an electric motor as a drive source, comprising:
a battery coupling section used for attaching a rechargeable slide-attaching type battery pack as a power source for the electric motor.
